(19) United States
(12) Patent Application Publication
(10) Pub. No.: US 2026/0204155 A1
(43) Pub. Date: Jul. 16, 2026

(54) SYSTEMS AND METHODS FOR TRAFFIC VEHICLE EMERGENCY MANAGEMENT BASED ON INTERNET OF THINGS (IOT) LARGE MODELS

(71) Applicant: CHENGDU QINCHUAN IOT TECHNOLOGY CO., LTD., Chengdu (CN)

(72) Inventors: Hanshu SHAO, Chengdu (CN); Junyan ZHOU, Chengdu (CN); Rui RU, Chengdu (CN); Siwei ZENG, Chengdu (CN)

(73) Assignee: CHENGDU QINCHUAN IOT TECHNOLOGY CO., LTD., Chengdu (CN)

(21) Appl. No.: 19/562,732

(22) Filed: Mar. 10, 2026

(30) Foreign Application Priority Data
Jan. 12, 2026 (CN) 202610030549.8

(51) Int. Cl. G08G 1/01; G08G 1/017; E01F 13/04

(52) U.S. Cl. CPC G08G 1/0145; G08G 1/0133; G08G 1/0141; G08G 1/017; E01F 13/04

(57) ABSTRACT

A method and a system for traffic vehicle emergency management based on an Internet of Things (IoT) large model are provided. The method includes: determining a first anomaly confidence level of each of at least one vehicle; in response to the first anomaly confidence level being greater than a confidence threshold, determining an anomalous vehicle, a second anomaly confidence level of the anomalous vehicle, and an anomaly type of the anomalous vehicle through an anomalous vehicle monitoring model; determining a control type and a control parameter based on the anomalous vehicle, the second anomaly confidence level of the anomalous vehicle, and the anomaly type of the anomalous vehicle; and in response to the control type being anomalous vehicle control, issuing an early warning on a travel route of the anomalous vehicle via the early warning device.

### CROSS-REFERENCE TO RELATED APPLICATIONS

This application claims priority to Chinese Patent Application No. 202610030549.8, filed on January 12, 2026, the entire contents of which are incorporated herein by reference.

### TECHNICAL FIELD

The present disclosure relates to the field of vehicle monitoring, and in particular, to a system and a method for traffic vehicle emergency management based on an Internet of Things (IoT) large model.

### BACKGROUND

With the acceleration of urbanization, the number of vehicles continues to increase, and the traffic environment is becoming increasingly complex. The presence of anomalous vehicles (such as malfunctioning vehicles, speeding vehicles, hit-and-run vehicles, etc.) poses a serious threat to road traffic safety. The anomalous vehicles may trigger traffic accidents or even endanger the lives of pedestrians. Therefore, timely identification and early warning of the anomalous vehicles is an urgent problem to be solved in urban traffic management.

Currently, a large number of monitoring devices and sensing devices have been deployed in cities, such as traffic cameras, radar speed meters, and vehicle identification systems. Although these monitoring and sensing devices can collect a large amount of traffic data, they have numerous shortcomings in the identification and early warning of anomalous vehicles. On one hand, the data collected by existing monitoring and sensing devices are mostly isolated fragments of information. Data from different devices are difficult to effectively integrate and collaboratively analyze, leading to severe information silos and an inability to form a complete traffic situation awareness. On the other hand, existing methods for identifying anomalous vehicles mostly rely on simple rule matching or manual monitoring, lacking the capacity for deep mining and intelligent analysis of massive data. This makes it difficult to accurately identify and provide real-time warnings for anomalous vehicles, failing to meet the safety management requirements of complex urban traffic environments. There is a lack of multi-source collaborative perception capability for sudden incidents in complex traffic scenarios (such as malicious cutting in, or breakdown stranding), resulting in delayed responses to abnormalities and a high risk of triggering secondary accidents.

Therefore, there is an urgent need to provide a system and a method for traffic vehicle emergency management based on an IoT large model. The system aims to achieve cross-device collaborative positioning of abnormal targets for their timely management and control by integrating in-vehicle dynamic data and roadside multi-dimensional perception data.

### SUMMARY

One or more embodiments of the present disclosure provide a system for traffic vehicle emergency management based on an IoT large model. The system comprises a government supervision management platform, a government supervision sensor network platform, a government supervision object platform, a smart vehicle sensor network platform, and a smart vehicle device object platform that are sequentially connected. The government supervision management platform is configured to: determine a first anomaly confidence level of each of at least one vehicle based on a vehicle operational trajectory, vehicle thermal data, and acoustic data of each of the at least one vehicle in at least one monitoring region of a target road; in response to the first anomaly confidence level being greater than a confidence threshold, determine an anomalous vehicle, a second anomaly confidence level of the anomalous vehicle, and an anomaly type of the anomalous vehicle through an anomalous vehicle monitoring model based on vehicle sequence data of each of the at least one vehicle within a first preset time period, wherein the anomalous vehicle monitoring model is a machine learning model; determine a control type and a control parameter based on the anomalous vehicle, the second anomaly confidence level of the anomalous vehicle, and the anomaly type of the anomalous vehicle, wherein the control parameter includes a warning parameter of an early warning device; and in response to the control type being anomalous vehicle control, issue an early warning on a travel route of the anomalous vehicle via the early warning device.

One or more embodiments of the present disclosure provide a method for traffic vehicle emergency management based on an IoT large model, the method being executed by a government supervision management platform of a system for traffic vehicle emergency management based on the IoT large model. The method comprises: determining a first anomaly confidence level of each of at least one vehicle based on a vehicle operational trajectory, vehicle thermal data, and acoustic data of each of the at least one vehicle in at least one monitoring region of a target road; in response to the first anomaly confidence level being greater than a confidence threshold, determining an anomalous vehicle, a second anomaly confidence level of the anomalous vehicle, and an anomaly type of the anomalous vehicle through an anomalous vehicle monitoring model based on vehicle sequence data of each of the at least one vehicle within a first preset time period, wherein the anomalous vehicle monitoring model is a machine learning model; determining a control type and a control parameter based on the anomalous vehicle, the second anomaly confidence level of the anomalous vehicle, and the anomaly type of the anomalous vehicle, wherein the control parameter includes a warning parameter of an early warning device; and in response to the control type being anomalous vehicle control, issuing an early warning on a travel route of the anomalous vehicle via the early warning device.

One or more embodiments of the present disclosure provide a non-transitory computer-readable storage medium storing computer instructions, wherein after reading the computer instructions in the storage medium, a computer executes the method for traffic vehicle emergency management based on the IoT large model in the preset disclosure.

Some embodiments of the present disclosure provide at least the following beneficial effects. By determining the anomalous vehicle based on the first anomaly confidence level, the second anomaly confidence level, and the anomaly type, and further determining the control type and the control parameter to activate the anomalous vehicle’s warning lights, it is possible to comprehensively utilize monitoring data for the same vehicle obtained from monitoring devices and sensing devices at multiple locations. This enables the identification of anomalous vehicles and analysis of the causes of anomalies, thereby facilitating timely and effective vehicle management and control.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, wherein:

FIG. 1 is a schematic diagram illustrating a platform structure of a system for traffic vehicle emergency management based on an IoT large model according to some embodiments of the present disclosure;

FIG. 2 is a flowchart illustrating an exemplary process of a method for traffic vehicle emergency management based on an IoT large model according to some embodiments of the present disclosure;

FIG. 3 is a schematic diagram of an exemplary anomalous vehicle monitoring model according to some embodiments of the present disclosure; and

FIG. 4 is a schematic diagram illustrating the determination of a control type and a control parameter according to some embodiments of the present disclosure.

### DETAILED DESCRIPTION

In order to provide a clearer understanding of the technical solutions of the embodiments described in the present disclosure, a brief introduction to the drawings required in the description of the embodiments is given below. It is evident that the drawings described below are merely some examples or embodiments of the present disclosure, and for those skilled in the art, the present disclosure may be applied to other similar situations without exercising creative labor. Unless otherwise indicated or stated in the context, the same reference numerals in the drawings represent the same structures or operations.

It should be understood that the terms “system,” “device,” “unit,” and/or “module” used herein are ways for distinguishing different levels of components, elements, parts, or assemblies. However, if other terms can achieve the same purpose, they may be used as alternatives.

As indicated in the present disclosure and in the claims, the singular forms “a,” “an,” and “the” may be intended to include the plural forms as well, unless the context clearly indicates otherwise. In general, the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

Flowcharts are used in the present disclosure to illustrate the operations performed by the system according to the embodiments described herein. It should be understood that the operations may not necessarily be performed in the exact sequence depicted. Instead, the operations may be performed in reverse order or concurrently. Additionally, other operations may be added to these processes, or one or more operations may be removed.

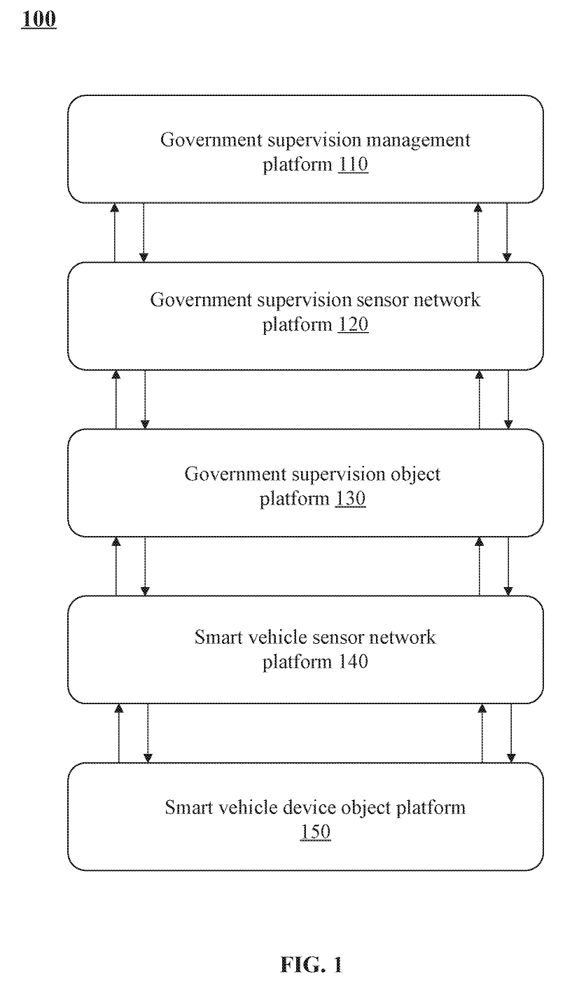

FIG. 1 is a schematic diagram illustrating a platform structure of a system for traffic vehicle emergency management based on an IoT large model according to some embodiments of the present disclosure.

In some embodiments, as shown in FIG. 1, a system 100 for traffic vehicle emergency management based on an IoT large model (also referred to as the system 100 or the traffic vehicle emergency management system 100) includes a government supervision management platform 110, a government supervision sensor network platform 120, a government supervision object platform 130, a smart vehicle sensor network platform 140, and a smart vehicle device object platform 150 that are sequentially connected.

In some embodiments, one or more platforms in the system 100 exchange information and/or data through a network. In some embodiments, the network is any one or more of a wired network or a wireless network.

The government supervision management platform 110 refers to a platform for supervising and managing data related to the system 100, and includes a processor or a server. Merely by way of example, the processor includes a central processing unit (CPU), an application-specific integrated circuit (ASIC), etc., or any combination thereof.

In some embodiments, the government supervision management platform 110 is configured to: determine a first anomaly confidence level of each of at least one vehicle based on a vehicle trajectory, vehicle thermal data, and acoustic data of each of the at least one vehicle in at least one monitoring region of a target road; in response to the first anomaly confidence level being greater than a confidence threshold, determine an anomalous vehicle, a second anomaly confidence level of the anomalous vehicle, and an anomaly type of the anomalous vehicle based on vehicle sequence data of each of the at least one vehicle within a first preset time period by using an anomalous vehicle monitoring model, wherein the anomalous vehicle monitoring model is a machine learning model. The government supervision management platform 110 is further configured to: determine a control type and a control parameter based on the anomalous vehicle, the second anomaly confidence level of the anomalous vehicle, and the anomaly type of the anomalous vehicle, wherein the control parameter includes a warning parameter of an early warning device; and in response to the control type being anomalous vehicle control, perform an early warning on a travel route of the anomalous vehicle via the early warning device.

In some embodiments, the government supervision management platform 110 is further configured to: determine an anomaly monitoring region containing an anomalous trajectory based on the vehicle operational trajectory of each of the at least one vehicle and a reference trajectory; and determine the first anomaly confidence level of each of the at least one vehicle based on the anomalous trajectory, the vehicle thermal data, and the acoustic data of the anomaly monitoring region.

In some embodiments, the government supervision management platform 110 is further configured to: determine a spatiotemporal trajectory distribution based on the vehicle operational trajectory of each of the at least one vehicle within a second preset time period; and determine the reference trajectory based on the spatiotemporal trajectory distribution and a current time period.

In some embodiments, the government supervision management platform 110 is further configured to: determine the first anomaly confidence level of each of the at least one vehicle through a vehicle identification multimodal model based on the anomalous trajectory, the vehicle thermal data, and the acoustic data of the anomaly monitoring region, wherein the vehicle identification multimodal model is a machine learning model.

In some embodiments, the government supervision management platform 110 is further configured to: determine a risk value based on the second anomaly confidence level and the anomaly type of the anomalous vehicle; determine the control type and the control parameter based on the risk value; in response to the control type including non-anomalous vehicle control, control, based on the broadcast parameter, the broadcast device of the target non-anomalous vehicle to operate to implement broadcasting to the target non-anomalous vehicle; and in response to the control type including road control, control, based on the road closure parameter, a barrier gate arm of the lane to be closed to descend to achieve lane closure.

In some embodiments, the government supervision management platform 110 is further configured to: when the control type includes the road control, in response to a duration for which a current lane has been closed being equal to the closure duration, control the barrier gate arm of a closed lane to ascend to achieve lane reopening.

The government supervision sensor network platform 120 refers to a functional platform for sensor communication, and includes a communication network and a gateway. The government supervision sensor network platform 120 is configured to perform one or more of the following functions: network management, protocol management, command management, and data parsing.

In some embodiments, the government supervision sensor network platform 120 is used for communication interaction between the government supervision management platform 110 and the government supervision object platform 130. For example, the government supervision sensor network platform 120 receives an instruction for acquiring vehicle sequence data issued by the government supervision management platform 110, and sends the vehicle sequence data to the government supervision management platform 110. As another example, the government supervision sensor network platform 120 receives the vehicle sequence data uploaded by the government supervision object platform 130, or issues an instruction for acquiring the vehicle sequence data to the government supervision object platform 130.

The government supervision object platform 130 refers to a platform for collecting urban vehicle data and executing related instructions. The government supervision object platform 130 includes an urban radar, an infrared sensor, an acoustic radar, or the like.

In some embodiments, the government supervision object platform 130 interacts with the government supervision sensor network platform 120 and the smart vehicle sensor network platform 140. For example, the government supervision object platform 130 acquires vehicle sequence data from the smart vehicle device object platform 150 via the smart vehicle sensor network platform 140, and sends the vehicle sequence data to the government supervision management platform 110 via the government supervision sensor network platform 120.

In some embodiments, the government supervision object platform 130 is configured to acquire urban vehicle data. The urban vehicle data includes vehicle operation data, vehicle thermal data, acoustic data, etc. For example, the government supervision object platform 130 acquires a vehicle trajectory from a city radar, acquires vehicle thermal data from an infrared sensor, and acquires acoustic data from an acoustic radar.

In some embodiments, the city radar, the infrared sensor, and the acoustic radar are configured on at least one road segment in an urban road network. The city radar is configured to monitor a vehicle trajectory on the road segment. The infrared sensor is configured to monitor vehicle thermal data on the road segment. The acoustic radar is configured to monitor acoustic data on the road segment.

In some embodiments, a communication module is configured for communication and information transmission between various platforms and devices in the system 100.

In some embodiments, a second processor processes information and/or data related to the system 100 to perform functions described in one or more embodiments of the present disclosure.

The smart vehicle sensor network platform 140 refers to a platform that manages sensor information of vehicles, and includes a communication device or a server. In some embodiments, the smart vehicle sensor network platform 140 is configured for communication interaction between the government supervision object platform 130 and the smart vehicle device object platform 150.

The smart vehicle device object platform 150 refers to a functional platform configured to acquire the vehicle sequence data or execute related instructions. The smart vehicle device object platform 150 includes vehicles, broadcast devices, etc.

In some embodiments, the smart vehicle device object platform 150 includes an Internet of Vehicles (IoV) monitoring matrix.

In some embodiments, the IoV monitoring matrix is configured on at least one vehicle to monitor the vehicle sequence data of the vehicle. The IoV monitoring matrix refers to a sensor matrix composed of a plurality of sensors deployed on a vehicle. In some embodiments, the IoV monitoring matrix is composed of a pressure sensor under a seat, a pressure sensor on a steering wheel, and a vehicle speed sensor.

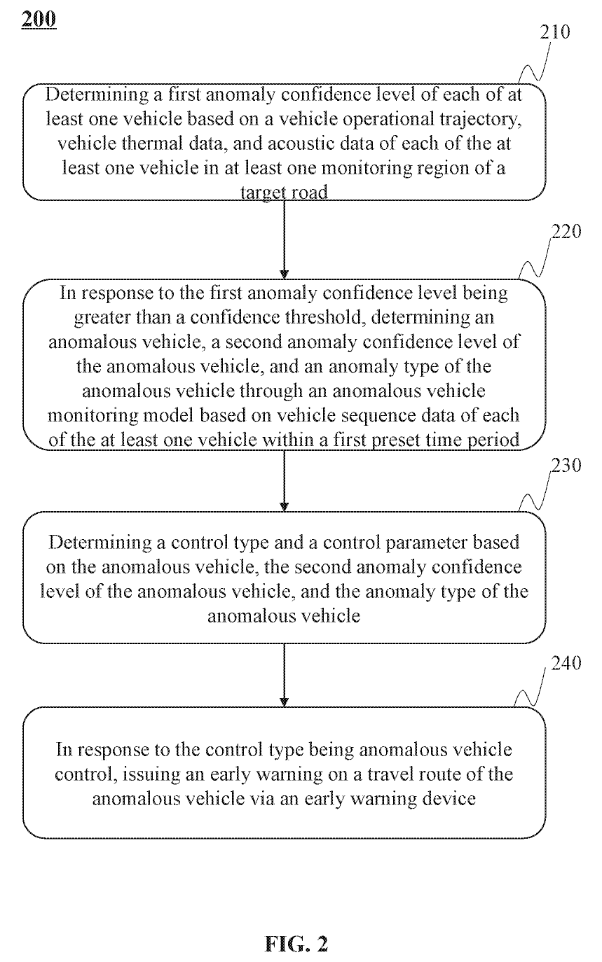

More descriptions regarding the above platforms may be found in FIG. 2 to FIG. 4 and related descriptions.

In some embodiments, the system 100 forms an information operation closed loop among the various functional platforms. Under the unified management of the government supervision management platform, the system 100 operates in a coordinated and regular manner, thereby achieving information-based and smart vehicle supervision.

It should be noted that the above descriptions of the system 100 is for illustrative purposes only and do not limit the present disclosure to the described embodiments.

FIG. 2 is a flowchart illustrating an exemplary process of a method for traffic vehicle emergency management based on an IoT large model according to some embodiments of the present disclosure. Process 200 is an exemplary process of a method for traffic vehicle emergency management based on an IoT large model. In some embodiments, process 200 may be executed by the government supervision management platform 110. Process 200 may include steps 210-240.

In 210, determine a first anomaly confidence level of each of at least one vehicle based on a vehicle operational trajectory, vehicle thermal data, and acoustic data of each of the at least one vehicle in at least one monitoring region of a target road.

The target road refers to a road requiring monitoring and management control.

In some embodiments, the government supervision management platform may determine the target road in various ways. For example, the government supervision management platform may identify a road experiencing congestion by reading relevant data from mapping software and designate the road as the target road.

A monitoring region refers to a region of the target road that is covered and monitored by one or more monitoring devices.

In some embodiments, the government supervision management platform may designate a region of the target road that is monitored by one or more monitoring devices as the monitoring region. At least one monitoring device is configured on the target road.

The vehicle operational trajectory refers to a path of a vehicle along the target road. In some embodiments, the vehicle operational trajectory may be represented by a curve. Vehicles include anomalous vehicle(s) and target vehicle(s). An anomalous vehicle is a vehicle of which the vehicle operational trajectory, the vehicle thermal data, or the acoustic data is abnormal. A target vehicle refers to any vehicle other than the anomalous vehicles.

In some embodiments, the government supervision management platform may determine the vehicle operational trajectory based on positioning equipment. The positioning equipment may include city radar, the Global Positioning System (GPS), the BeiDou Navigation Satellite System (BDS), etc.

The vehicle thermal data of a vehicle refers to data related to the temperature of the vehicle. In some embodiments, the vehicle thermal data may be represented as an infrared thermal imaging image. For example, the vehicle thermal data may be an infrared thermal imaging image that includes the temperature of the vehicle on the target road.

In some embodiments, the government supervision management platform may determine the vehicle thermal data via an infrared sensor. The infrared sensor may be integrated within the monitoring device or deployed separately on the target road.

The acoustic data of a vehicle refers to sound emitted by the vehicle during travelling.

In some embodiments, the government supervision management platform may determine the acoustic data of the vehicle via an acoustic radar. The acoustic radar may be integrated within the monitoring device or deployed separately on the target road.

The first anomaly confidence level of a vehicle is an indicator for determining whether the vehicle is abnormal. In some embodiments, the first anomaly confidence level may represent a credibility of a vehicle anomaly. The higher the first anomaly confidence level of a vehicle is, the greater the likelihood that an operating state of the vehicle is abnormal.

In some embodiments, the government supervision management platform may determine a trajectory score, a thermal score, and an acoustic score based on the vehicle operational trajectory, the vehicle thermal data, and the acoustic data of each of the at least one vehicle in the at least one monitoring region of the target road. The first anomaly confidence level of each of the at least one vehicle is then determined based on the trajectory score, the thermal score, and the acoustic score. The trajectory score represents an abnormality of the vehicle operational trajectory, the thermal score represents an abnormality of the temperature of the vehicle, and the acoustic score represents an abnormality of the sound produced by the vehicle during operation.

In some embodiments, for each vehicle among the at least one vehicle, the government supervision management platform may determine, based on the vehicle operational trajectory of the vehicle and a road centerline of the target road, a curvature of the road centerline and a curvature of the vehicle operational trajectory of the vehicle. A difference between the curvature of the road centerline and the curvature of the vehicle operational trajectory of the vehicle is then determined as the trajectory score of the vehicle.

In some embodiments, for each vehicle among the at least one vehicle, the government supervision management platform may determine a difference between a standard vehicle thermal value and the thermal data of the vehicle as the thermal score of the vehicle.

In some embodiments, for each vehicle among the at least one vehicle, the government supervision management platform may perform noise reduction, segmentation, and normalization on the acoustic data acquired by the acoustic radar. Based on normal acoustic data of the vehicle, a reference baseline of the normal acoustic data is determined. An average value of differences between acoustic features of all segmented acoustic data and the reference baseline is determined as the acoustic score. The trajectory score, the thermal score, and the sound score of the vehicle are respectively normalized and then weighted and summed, and the resulting weighted sum is determined as the first abnormality confidence level of the vehicle. In some embodiments, the weights may be preset by technical personnel based on experience.

In some embodiments, the government supervision management platform may perform noise reduction on the acoustic data using a noise reduction algorithm (e.g., frequency domain filtering, wavelet transform, etc.), segment the acoustic data based on a preset step size (e.g., 10 milliseconds), determine a first standard deviation based on the amplitude of acoustic signals in the acoustic data, and normalize the acoustic data based on the first standard deviation. The preset step size may be established by technical personnel based on experience.

In some embodiments, the government supervision management platform may pre-record sound of the vehicle operating under a normal condition on the target road and designate the sound as the normal acoustic data.

In some embodiments, the government supervision management platform may determine an average amplitude and a second standard deviation of acoustic signals within the normal acoustic data, and designate a sum of the average amplitude and the second standard deviation as the reference baseline for the normal acoustic data.

In some embodiments, the government supervision management platform may normalize the trajectory score based on a maximum value among trajectory scores of the at least one vehicle, normalize the thermal score based on a maximum value among thermal scores of the at least one vehicle, and normalize the acoustic score based on a maximum value among acoustic scores of the at least one vehicle.

In some embodiments, the government supervision management platform may further determine an anomaly monitoring region containing an anomalous operational trajectory based on the vehicle operational trajectory of each of the at least one vehicle and a reference trajectory. Then, the government supervision management platform may determine the first anomaly confidence level of each of the at least one vehicle based on the anomalous operational trajectory, the vehicle thermal data, and the acoustic data of the anomaly monitoring region.

The reference trajectory refers to a travel trajectory of the target vehicle operating normally during a historical time period.

In some embodiments, the government supervision management platform may acquire the travel trajectory of the target vehicle via the monitoring device and designate the travel trajectory as the reference trajectory.

In some embodiments, the government supervision management platform may determine a spatiotemporal trajectory distribution based on the vehicle operational trajectory of each of the at least one vehicle within a second preset time period. Subsequently, the government supervision management platform determines the reference trajectory based on the spatiotemporal trajectory distribution and a current time period.

The second preset time period is a predefined historical time period.

In some embodiments, the second preset time period is related to a road control intensity of the target road. The government supervision management platform may determine the second preset time period based on the road control intensity of the target road. For example, a stronger road control intensity for the target road corresponds to a shorter duration for the second preset time period.

In some embodiments of the present disclosure, correlating the second preset time period with the road control intensity of the target road helps improve the flexibility and adaptability of road management, enabling the government supervision management platform to perceive road conditions in real-time and make dynamic adjustments based on the road control intensity.

The spatiotemporal trajectory distribution refers to a distribution characteristics of operational trajectories of vehicles across time and space.

In some embodiments, the government supervision management platform may determine the spatiotemporal trajectory distribution by performing cluster analysis on the vehicle operational trajectory of each of at least one vehicle within the second preset time period.

For example, the government supervision management platform may acquire the operational trajectories of multiple target vehicles in multiple monitoring regions of the target road within the second preset time period. Based on a collection time and a collection lane of each of the operational trajectories, the government supervision management platform may categorize the multiple vehicle trajectories into trajectory databases corresponding to different sub-periods and different lanes. For the trajectory database of each lane in each sub-period, the government supervision management platform can determine a sampling frequency based on the road control intensity of the road to which the trajectory database belongs and the sub-period the trajectory database represents. Using the sampling frequency, the government supervision management platform selects multiple sample operational trajectories from the trajectory database. Based on the multiple sample operational trajectories, the government supervision management platform employs a spatial-overlap-based trajectory clustering technique to determine a characteristic vehicle operational trajectory for the lane during that sub-period. Finally, by combining characteristic operational trajectories from all lanes across all sub-periods within the second preset time period of the target road, the spatiotemporal trajectory distribution is determined.

In some embodiments, the spatial-overlap-based trajectory clustering technique includes: discretizing the multiple sample operational trajectories into multiple discrete point sequences and integrating the multiple discrete point sequences into a common planar space based on spatial overlap; performing clustering on the discrete points from the multiple discrete point sequences using spatial density-based clustering to form multiple clusters; determining a geometric center of each cluster; and connecting geometric centers of all clusters in spatial order to form the characteristic vehicle operational trajectory for a lane during a sub-period.

A sub-period refers to a time segment pre-divided from the second preset time period based on partitioning criteria. The partitioning criteria may be preset by technical personnel based on experience. A lane refers to a specific region within the target road designated for vehicle travel. The sampling frequency is related to the road control intensity of the target road, meaning that a higher road control intensity corresponds to a higher sampling frequency.

The current time period refers to a time period during which the target road is currently being monitored.

In some embodiments, the government supervision management platform may determine the reference trajectory from the spatiotemporal trajectory distribution based on the current time period. For example, the government supervision management platform may identify a characteristic vehicle operational trajectory corresponding to a sub-period within the spatiotemporal trajectory distribution that is equal or closest to the current time period and designate the characteristic vehicle operational trajectory as the reference trajectory.

In some embodiments of the present disclosure, since road traffic conditions may change at any time, certain patterns often emerge within specific time frames. By analyzing data from recent historical periods, traffic patterns—such as those caused by rush hours or temporary road work—can be identified. Analyzing data from the most recent period enables a better understanding of these patterns, thereby allowing the system to more accurately reflect the current situation.

The anomalous operational trajectory refers to one or more vehicle operational trajectories that exhibit abnormalities.

In some embodiments, the government supervision management platform may determine the anomalous operational trajectory based on the reference trajectory. For example, the platform may identify a vehicle operational trajectory that significantly deviates from the reference trajectory (e.g., a vehicle operational trajectory that has a low similarity to the reference trajectory) as the anomalous operational trajectory.

The anomalous monitoring region refers to a monitoring region where anomalous operational trajectories are present.

In some embodiments, the government supervision management platform may designate a monitoring region to which an anomalous operational trajectory belongs as the anomalous monitoring region.

In some embodiments, the government supervision management platform may determine the first anomaly confidence level of each of the at least one vehicle in various ways, based on the anomalous operational trajectory, the vehicle thermal data, and the acoustic data of the anomalous monitoring region.

In some embodiments, the government supervision management platform may determine the first anomaly confidence level based on the anomalous operational trajectory, the vehicle thermal data, and the acoustic data of the anomalous monitoring region, through a manner similar to that employed for determining the first anomaly confidence level based on the vehicle operational trajectory, the vehicle thermal data, and the acoustic data. For further details, please refer to the relevant descriptions provided earlier, which will not be repeated here.

In some embodiments, the government supervision management platform may determine the first anomaly confidence level of each of the at least one vehicle by processing the anomalous operational trajectory, the vehicle thermal data, and the acoustic data of the anomalous monitoring region through a vehicle identification multimodal model.

The vehicle identification multimodal model refers to a model configured to determine the first anomaly confidence level of a vehicle. In some embodiments, the vehicle identification multimodal model may be a machine learning model, such as a Convolutional Neural Network (CNN).

In some embodiments, an input of the vehicle identification multimodal model may include the anomalous operational trajectory, the vehicle thermal data, and the acoustic data of the anomalous monitoring region. An output of the vehicle identification multimodal model may include the first anomaly confidence level of the vehicle.

In some embodiments, the vehicle identification multimodal model may be trained using a large number of first training samples with first training labels. A set of first training samples may include sample anomalous operational trajectories, sample vehicle thermal data, and sample acoustic data of multiple anomalous monitoring regions. The first training label corresponding to a set of first training samples is a sample first anomaly confidence level.

The first training samples may be determined based on historical data. The historical data includes historical anomalous operational trajectories, historical vehicle thermal data, and historical acoustic data of the anomalous monitoring regions intended for analysis. For each first training sample, technical personnel may review historical monitoring videos and mark the first anomaly confidence level as 0 for vehicles without anomalous behavior. For vehicles exhibiting anomalous behavior, the first anomaly confidence level is labeled based on the count of anomalous behaviors observed. Each anomalous behavior identified increments the vehicle's first anomaly confidence level by 1. In other words, a larger count of anomalous behaviors results in a higher first anomaly confidence level. Anomalous behaviors may include unsteady vehicle operational trajectories, traffic rule violations, anomalous vehicle speed, etc.

In some embodiments, the government supervision management platform may perform multiple rounds of iterative training on an initial vehicle identification multimodal model using multiple sets of first training samples with first training labels. Training continues until a stopping condition is met, resulting in a trained vehicle identification multimodal model. At least one round of iterative training includes: selecting one or more first training samples from a training dataset; inputting the one or more first training samples into the initial vehicle identification multimodal model to obtain the model's predicted output corresponding to the one or more first training samples; substituting the model's predicted output for the one or more first training samples and their corresponding first training labels into a predefined loss function formula to determine a value of the loss function; and iteratively updating model parameters of the initial vehicle identification multimodal model based on the value of the loss function until the stopping condition is met, concluding the iteration and yielding the trained model. The iterative updating of the model parameters may be performed using various techniques, such as gradient descent. The stopping condition may include convergence of the loss function, the count of the iteration reaching a predefined threshold, the value of the loss function being less than a preset threshold, etc.

In some embodiments of the present disclosure, using the vehicle identification multimodal model to determine the first anomaly confidence level enables rapid processing of complex and redundant data, which helps improve the efficiency of data processing, thereby enhancing the accuracy of the subsequently predicted first anomaly confidence level.

In some embodiments, the input of the vehicle identification multimodal model further includes a vehicle type and a vehicle load of the anomalous monitoring region. The vehicle type refers to a functional purpose of the vehicle, and the vehicle load refers to a passenger capacity or cargo weight of the vehicle.

In some embodiments, the first training samples may further include sample vehicle types and sample vehicle loads.

In some embodiments of the present disclosure, incorporating the vehicle type and the vehicle load as inputs to the vehicle identification multimodal model can significantly improve the model's accuracy, generalization capability, interpretability, and robustness, thereby optimizing resource allocation, reducing false positives, and consequently enhancing the efficiency and safety of traffic management.

In some embodiments of the present disclosure, determining the first anomaly confidence level of each of the at least one vehicle based on the anomalous operational trajectory, the vehicle thermal data, and the acoustic data facilitates more accurate identification of anomalous monitoring region(s) and anomalous vehicle(s). This approach improves the accuracy of anomaly detection, optimizes resource allocation, reduces data processing volume, accelerates processing speed, enhances system responsiveness, and ultimately increases the efficiency and effectiveness of traffic management.

In 220, in response to the first anomaly confidence level being greater than a confidence threshold, determining an anomalous vehicle, a second anomaly confidence level of the anomalous vehicle, and an anomaly type of the anomalous vehicle through an anomalous vehicle monitoring model based on vehicle sequence data of each of the at least one vehicle within a first preset time period.

The confidence threshold refers to a minimum first anomaly confidence level used to determine whether a vehicle exhibits an abnormal condition.

In some embodiments, the confidence threshold may be preset by technical personnel based on experience.

The first preset time period refers to a historical time period used for acquiring the vehicle sequence data.

In some embodiments, the first preset time period may be preset by technical personnel based on experience.

The vehicle sequence data of a vehicle refers to relevant data of the vehicle within the first preset time period. The vehicle sequence data may include tire pressure sequence data, brake sequence data, Anti-lock Braking System (ABS) information (hereinafter referred to as ABS information), seat pressure sequence data, steering wheel pressure sequence data, a vehicle travel time, etc.

The tire pressure sequence data may include tire pressure data of multiple tires at multiple time points within the first preset time period.

The brake sequence data may include multiple braking durations and multiple braking time points within the first preset time period.

The seat pressure sequence data may include pressure values of multiple seats at multiple time points within the first preset time period.

The steering wheel pressure sequence data may include pressure values of a steering wheel at multiple time points within the first preset time period.

The ABS information may include rotational speeds at multiple time points and the count of ABS activations within the first preset time period.

In some embodiments, the government supervision management platform may collect the ABS information via an Internet of Vehicles (IoV) embedded matrix (e.g., in-vehicle embedded sensors, Electronic Control Units (ECUs)).

In some embodiments, the government supervision management platform can acquire the vehicle sequence data based on an IoV monitoring matrix. The IoV monitoring matrix may include a tire pressure sensor, a seat pressure sensor, a steering wheel pressure sensor, a brake monitoring sensor, etc.

The anomalous vehicle refers to one or more vehicles exhibiting an abnormal condition. For example, the anomalous vehicle may include a vehicle with abnormal tire pressure, a vehicle with an abnormal brake pad, a vehicle with an abnormal Anti-lock Braking System, etc.

The second anomaly confidence level may be used as an indicator to measure a degree of abnormality of the anomalous vehicle. A higher second anomaly confidence level indicates a greater degree of abnormality in the anomalous vehicle.

The anomaly type refers to different abnormal conditions categorized based on different vehicle sequence data. For example, the anomaly type may include a vehicle anomaly and a driver behavior anomaly. The driver behavior anomaly may include the driver using a mobile phone, violating traffic rules (e.g., speeding, driving in the wrong direction, frequent lane changes, rapid acceleration, rapid deceleration, etc.), emotional abnormalities (e.g., anger, anxiety, nervousness, etc.), or he like.

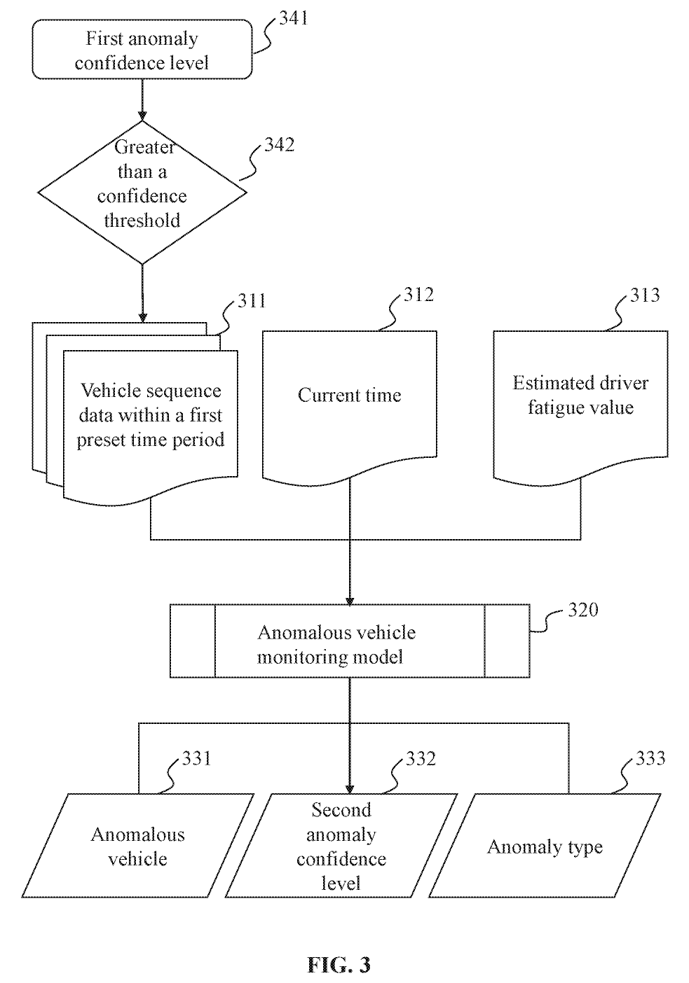

For further details regarding determining the anomalous vehicle, the second anomaly confidence level of the anomalous vehicle, and the anomaly type of the anomalous vehicle through the anomalous vehicle monitoring model, please refer to FIG. 3 and its related description.

In 230, determining a control type and a control parameter based on the anomalous vehicle, the second anomaly confidence level of the anomalous vehicle, and the anomaly type of the anomalous vehicle.

The control type may include control over the anomalous vehicle and/or control over the target road.

In some embodiments, the government supervision management platform may determine the control type and the control parameter by querying a first preset table based on the anomalous vehicle, the second anomaly confidence level of the anomalous vehicle, and the anomaly type of the anomalous vehicle. The first preset table includes a relationship between anomalous vehicles, second anomaly confidence levels of the anomalous vehicles, anomaly types of the anomalous vehicles, and the corresponding control types and control parameters. The first preset table may be predefined by technical personnel based on experience.

The control parameter refers to one or more relevant parameters used for managing and controlling the target road. The control parameter may include a warning parameter of an early warning device. The early warning device may include an electronic warning sign, a traffic light, a broadcast system, etc., installed along a travel route. The warning parameter refers to the one or more parameters used to control the operation of the early warning device. For example, the warning parameter may include content displayed on the electronic warning sign, a color and a duration of the traffic light, content of broadcast announcements, etc.

In some embodiments, the government supervision management platform may determine the control parameter based on the anomaly type. For example, if the anomaly type is the vehicle anomaly, the control type is determined to be anomalous vehicle control, and the control parameter is to activate the early warning device for alerting. If the anomaly type is the driver behavior anomaly, the control type is determined to be non-anomalous vehicle control, and the control parameter is to activate both external and internal warning lights on the vehicle.

In 240, in response to the control type being the anomalous vehicle control, issuing an early warning on the travel route of the anomalous vehicle via the early warning device.

In some embodiments, if the control type is the anomalous vehicle control, the government supervision management platform may generate a warning device control command based on the warning parameter to control the early warning device to issue a warning.

In some embodiments of the present disclosure, by determining the anomalous vehicle, the second anomaly confidence level of the anomalous vehicle, and the anomaly type of the anomalous vehicle based on the first anomaly confidence level, and further determining the control type and the control parameter to activate the anomalous vehicle's warning lights, it is possible to comprehensively utilize monitoring data for the same vehicle obtained from monitoring devices and sensing devices at multiple locations. This approach enables the identification of anomalous vehicles and analysis of the causes of the anomalies, thereby facilitating timely and effective vehicle management and control.

It should be noted that the foregoing description of process 200 is merely for illustration and explanation and does not limit the applicable scope of the present disclosure. Those skilled in the art may make various modifications and changes to process 200 under the guidance of the present disclosure. However, these modifications and changes still fall within the scope of the present disclosure.

FIG. 3 is a schematic diagram of an exemplary anomalous vehicle monitoring model according to some embodiments of the present disclosure.

In some embodiments, as shown in FIG. 3, in response to a first anomaly confidence level 340 being greater than a confidence threshold, the government supervision management platform determines an anomalous vehicle 331, a second anomaly confidence level 332 of the anomalous vehicle, and an anomaly type 333 of the anomalous vehicle 331 through an anomalous vehicle monitoring model 320 based on vehicle sequence data 311 of each of at least one vehicle within a first preset time period.

The anomalous vehicle monitoring model refers to a model configured to determine the anomalous vehicle, the second anomaly confidence level of the anomalous vehicle, and the anomaly type of the anomalous vehicle. In some embodiments, the anomalous vehicle monitoring model may be a machine learning model, such as a Convolutional Neural Network (CNN).

In some embodiments, as shown in FIG. 3, an input of the anomalous vehicle monitoring model 320 may include the vehicle sequence data 311 of each of the at least one vehicle within a first preset time period. An output of the anomalous vehicle monitoring model 320 may include the anomalous vehicle 331, the second anomaly confidence level 332, and the anomaly type 333.

In some embodiments, the anomalous vehicle monitoring model may be trained using a large number of second training samples with second training labels. A set of second training samples may include sample vehicle sequence data of each of the at least one vehicle within the first preset time period. The second training label corresponding to a set of second training samples is a sample second anomaly confidence level and a sample anomaly type.

The second training samples may be determined based on historical data. The historical data includes historical vehicle sequence data of each of the at least one vehicle within the first preset time period. For each second training sample, the government supervision management platform may subsequently, after an actual warning is issued, label the anomaly type based on an actual anomaly type recorded by duty personnel (e.g., traffic police) on a target road during the management and control of the vehicle, thereby determining the anomaly type of the anomalous vehicle. If the anomaly type is a vehicle anomaly, the duty personnel may retrieve the vehicle sequence data during management and control, determine a proportion of abnormally functioning vehicle functions relative to a total vehicle functions, and designate the proportion as the second anomaly confidence level. If the anomaly type is a driver behavior anomaly, the duty personnel may retrieve an in-vehicle driving video during management and control and, analyze the in-vehicle driving video through a computer recognition algorithm to identify the count of anomalous driving behaviors. A ratio of the count of anomalous driving behaviors to a time duration of is then designated as the second anomaly confidence level. The anomalous driving behaviors may include anomalous driving emotions, anomalous driving operations, driver fatigue, etc. The time duration may be a duration of the anomalous driving behaviors.

In some embodiments, the government supervision management platform may perform multiple rounds of iterative training on an initial anomalous vehicle monitoring model using multiple sets of second training samples with second training labels. Training concludes when a stopping condition is met, resulting in a trained anomalous vehicle monitoring model. At least one round of iterative training includes: selecting one or more second training samples from a training dataset; inputting the one or more second training samples into the initial anomalous vehicle monitoring model to obtain the model's predicted output for these samples; substituting the model's predicted output for the one or more first training samples and their corresponding second training labels into a predefined loss function formula to determine a value of the loss function; and iteratively updating model parameters of the initial anomalous vehicle monitoring model based on the value of the loss function until the stopping condition is met, concluding the iteration and obtaining the trained anomalous vehicle monitoring model. The iteratively updating the model parameters of the initial anomalous vehicle monitoring model may be performed using various techniques, for example, based on gradient descent. The stopping condition may be convergence of the loss function, the count of the iteration reaching a preset threshold, the value of the loss function being less than a preset threshold, etc.

In some embodiments, as shown in FIG. 3, the input of the anomalous vehicle monitoring model further includes a current time 312 and an estimated driver fatigue value 313.

The current time refers to a time period during which a monitoring device is currently operating.

The estimated driver fatigue value refers to a predicted potential future fatigue level of a driver. The estimated driver fatigue value may be represented numerically. A higher value indicates a higher estimated driver fatigue level.

In some embodiments, the government supervision management platform may determine a maximum allowable driving duration of the driver based on the vehicle type and a driver age, and then determine the estimated driver fatigue value based on the maximum allowable driving duration and a vehicle travel time.

In some embodiments, the government supervision management platform may determine the maximum allowable driving duration and the vehicle travel time by querying a second preset table. The second preset table includes a relationship between vehicle types, driver ages, and vehicle travel times. The second preset table may be predefined by technical personnel based on experience.

In some embodiments, the government supervision management platform may determine the estimated driver fatigue value based on a ratio between the vehicle travel time and the maximum allowable driving duration of the driver.

In some embodiments, the second training samples may further include a sample current time and a sample estimated driver fatigue value. The government supervision management platform may train the anomalous vehicle monitoring model using second training samples that include the sample current time and sample estimated driver fatigue value.

In some embodiments of the present disclosure, incorporating the current time and the estimated driver fatigue value as inputs to the anomalous vehicle monitoring model helps improve the accuracy of assessing the anomalous vehicle, the second anomaly confidence level, and the anomaly type.

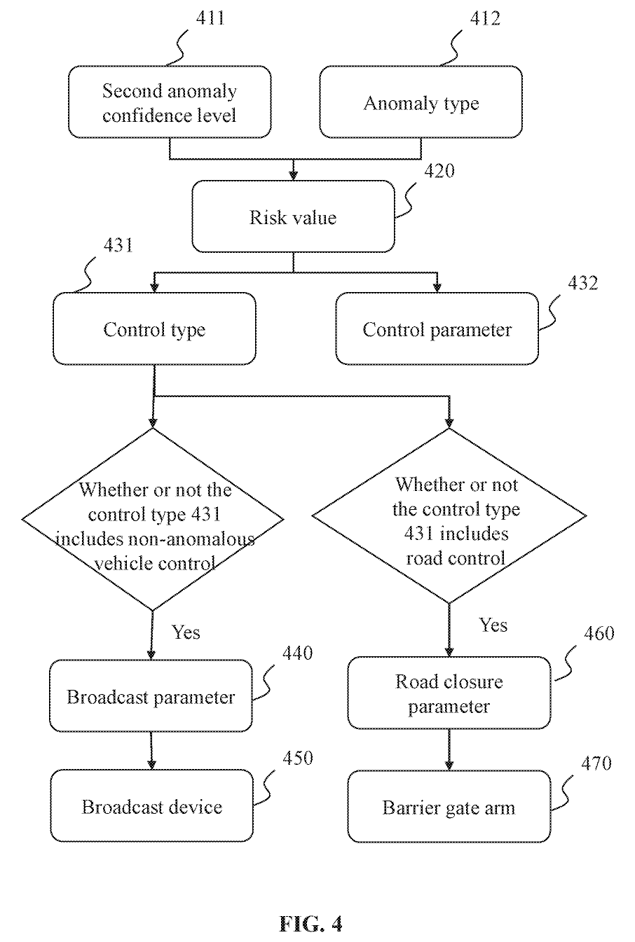

FIG. 4 is a schematic diagram illustrating the determination of a control type and a control parameter according to some embodiments of the present disclosure.

In some embodiments, as shown in FIG. 4, the smart vehicle device object platform 150 further includes a broadcast device 450. The control parameter 432 further includes at least one of a broadcast parameter 440 or a road closure parameter 460. The broadcast parameter 440 includes a target non-anomalous vehicle, and the road closure parameter 460 includes a lane to be closed. The government supervision management platform may determine a risk value 420 based on the second anomaly confidence level 411 and the anomaly type 412 of the anomalous vehicle; determine the control type 431 and the control parameter 432 based on the risk value 420; in response to the control type 431 including non-anomalous vehicle control, control the broadcast device 450 of the target non-anomalous vehicle to operate based on the broadcast parameter 440 to implement broadcasting to the target non-anomalous vehicle; and, in response to the control type 431 including road control, control a barrier gate arm 470 of the lane to be closed to descend based on the road closure parameter 460, to achieve lane closure.

The broadcast device refers to a device used to broadcast specific warning messages to designated vehicles. For example, the broadcast device may include a speaker, an audio system, etc.

In some embodiments, the control parameter further include the broadcast parameters and/or the road closure parameter.

The broadcast parameter refers to one or more parameters used to control the broadcast device for issuing warnings. In some embodiments, the broadcast parameter includes the target non-anomalous vehicle that needs to receive the broadcast. The target non-anomalous vehicle refers to one or more vehicles, other than the anomalous vehicle, that require regulation or control. In some embodiments, the target non-anomalous vehicle may include all vehicles within a preset radius centered around the anomalous vehicle.

The road closure parameter refers to one or more parameters used to control the road closure. In some embodiments, the road closure parameter may include the lane to be closed. The count of the lane to be closed may be one or more. In some embodiments, the government supervision management platform may designate a lane in which the anomalous vehicle is located as a center, and determine a preset count of lanes adjacent to the center as the lane to be closed.

The risk value is a parameter used to measure a hazard risk posed by the anomalous vehicle. The higher the risk value is, the greater the hazard risk associated with the anomalous vehicle is.

In some embodiments, the government supervision management platform determines the risk value in various ways based on the second anomaly confidence level and the anomaly type of the anomalous vehicle.

In some embodiments, the risk value is positively correlated with the second anomaly confidence level. In some embodiments, a positive correlation coefficient between the risk value and the second anomaly confidence level may differ depending on the risk type. For example, when the risk type is a driver behavior anomaly, the correlation coefficient is greater than when the risk type is a vehicle anomaly. In some embodiments, the positive correlation coefficient may be preset by technical personnel based on experience.

The non-anomalous vehicle control refers to a control type that involves intervening with target vehicle(s) other than the anomalous vehicle. In some embodiments, the non-anomalous vehicle control may include managing or rerouting the target vehicle(s) in the vicinity of the anomalous vehicle.

The road control refers to a control type that involves intervening with the road itself. In some embodiments, the road control may include first-level road control such as closing the lane in which the anomalous vehicle is located.

In some embodiments, the road control may further include second-level road control such as closing all lanes on upstream and downstream road sections connected to the road in which the anomalous vehicle is located.

In some embodiments, the government supervision management platform determines the control type and the control parameter based on the risk value according to a preset rule.

In some embodiments, the preset rule includes that when the risk value is less than a first risk threshold, the government supervision management platform determines the control type to be anomalous vehicle control, and the control parameter includes a warning parameter of an early warning device. In some embodiments, the preset rule includes that when the risk value is greater than or equal to the first risk threshold but less than or equal to a second risk threshold, the government supervision management platform determines that the control type includes both the anomalous vehicle control and the non-anomalous vehicle control, and the control parameter includes the warning parameter of the early warning device and the broadcast parameter.

In some embodiments, the preset rule includes that when the risk value is greater than the second risk threshold but less than or equal to a third risk threshold, the government supervision management platform determines that the control type includes the anomalous vehicle control, the non-anomalous vehicle control, and the first-level road control. The control parameter includes the warning parameter of the early warning device, the broadcast parameter, and the road closure parameter. In some embodiments, the preset rule includes that when the risk value is greater than the third risk threshold, the government supervision management platform determines that the control type includes the anomalous vehicle control, the non-anomalous vehicle control, the first-level road control, and the second-level road control. The control parameter includes the warning parameter of the early warning device, the broadcast parameter, and the road closure parameter, wherein the road closure parameter includes all lanes on the upstream and downstream road sections connected to the road where the vehicle is located. The first risk threshold, the second risk threshold, and the third risk threshold may be preset by technical personnel based on experience. The preset radius and the preset count are positively correlated with the risk value. The upstream and downstream road sections refer to roads directly connected to the current road. A road contains multiple lanes.

In some embodiments, in response to the control type including the non-anomalous vehicle control, the government supervision management platform controls the broadcast device of the target non-anomalous vehicle to operate based on the broadcast parameter to implement broadcasting to the target non-anomalous vehicle. For example, the government supervision management platform may generate a playback command based on the broadcast parameter and control the broadcast device of the target non-anomalous vehicle specified in the broadcast parameter to play a preset warning message based on the playback command.

In some embodiments, in response to the control type including the road control, the government supervision management platform controls the barrier gate arm of the lane to be closed to descend based on the road closure parameter to achieve lane closure. For example, the government supervision management platform may generate a closure command based on the road closure parameter and control the barrier gate arms of multiple lanes specified in the road closure parameter to descend.

In some embodiments of the present disclosure, determining the control parameter and the control type based on the risk value, and consequently implementing broadcasting to the target non-anomalous vehicle and lane closure, enables a balance between the risks inherent in the control process and the risks posed by traffic congestion. This approach aims to minimize both the hazards caused by the anomalous vehicle and the secondary hazards resulting from traffic blockages.

In some embodiments, the road closure parameter further includes a closure duration, which is related to a road control intensity. When the control type includes the road control, in response to a duration for which a current lane has been closed being equal to the closure duration, the government supervision management platform may control the barrier gate arm of the closed lane to ascend to achieve lane reopening.

The closure duration refers to a length of time a lane is closed. In some embodiments, the closure duration may be a time interval between the descending and subsequent ascending of the barrier gate arm of the lane.

In some embodiments, the closure duration is positively correlated with the road control intensity. The road control intensity refers to strictness of control imposed on a road. In some embodiments, the road control intensity may be determined based on at least one of a pedestrian flow or a vehicle flow of a road on which the anomalous vehicle is traveling. The pedestrian flow refers to the count of pedestrians on the road per unit time, and the vehicle flow refers to the count of vehicles on the road per unit time. For example, the higher the pedestrian flow and/or the vehicle flow on a road is, the higher an importance level of the road is, thus the greater the road control intensity of the road is.

In some embodiments of the present disclosure, using the vehicle flow and/or the pedestrian flow to reflect the importance level of a road allows for considering public traffic demand for roads requiring closure when implementing road closures, thereby facilitating a better balance between the risks inherent in the control process and the risks posed by traffic congestion.

Some embodiments of the present disclosure further provide a non-transitory computer-readable storage medium storing computer instructions. When a computer reads the instructions from the storage medium, the computer executes the method for traffic vehicle emergency management based on the IoT large model described in one or more embodiments of the present disclosure.

Having thus described the basic concepts, it may be rather apparent to those skilled in the art after reading this detailed disclosure that the foregoing detailed disclosure is intended to be presented as illustrative example and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of the present disclosure.

Moreover, certain terminology has been configured to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this disclosure are not necessarily all referring to the same embodiment. Furthermore, the particular features, structures, or characteristics may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be noted that in the foregoing description of embodiments of the present disclosure, various features are sometimes grouped together in a single embodiment, figure, or description thereof for the purpose of streamlining the disclosure aiding in the understanding of one or more of the various inventive embodiments. This way of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties configured to describe and claim certain embodiments of the present disclosure are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameter set forth in the written description and attached claims are approximations that may vary depending upon the desired properties sought to be obtained by a particular embodiment. In some embodiments, the numerical parameter should be construed in light of the number of reported significant digits and by applying ordinary rounding techniques. Notwithstanding that the numerical ranges and parameter setting forth the broad scope of some embodiments of the present disclosure are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the present disclosure disclosed herein are illustrating of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A system for traffic vehicle emergency management based on an Internet of Things (IoT) large model, comprising a government supervision management platform, a government supervision sensor network platform, a government supervision object platform, a smart vehicle sensor network platform, and a smart vehicle device object platform that are sequentially connected; wherein the government supervision management platform is configured to:
determine a first anomaly confidence level of each of at least one vehicle based on a vehicle operational trajectory, vehicle thermal data, and acoustic data of each of the at least one vehicle in at least one monitoring region of a target road;
in response to the first anomaly confidence level being greater than a confidence threshold, determine an anomalous vehicle, a second anomaly confidence level of the anomalous vehicle, and an anomaly type of the anomalous vehicle through an anomalous vehicle monitoring model based on vehicle sequence data of each of the at least one vehicle within a first preset time period, wherein the anomalous vehicle monitoring model is a machine learning model;
determine a control type and a control parameter based on the anomalous vehicle, the second anomaly confidence level of the anomalous vehicle, and the anomaly type of the anomalous vehicle, wherein the control parameter includes a warning parameter of an early warning device; and
in response to the control type being anomalous vehicle control, issue an early warning on a travel route of the anomalous vehicle via the early warning device.

2. The system according to claim 1, wherein an input of the anomalous vehicle monitoring model includes a current time and an estimated driver fatigue value, and the estimated driver fatigue value is determined based on a vehicle type, a driver age, and a vehicle travel time.

3. The system according to claim 1, wherein the government supervision management platform is further configured to:
determine an anomaly monitoring region containing an anomalous trajectory based on the vehicle operational trajectory of each of the at least one vehicle and a reference trajectory; and
determine the first anomaly confidence level of each of the at least one vehicle based on the anomalous trajectory, the vehicle thermal data, and the acoustic data of the anomaly monitoring region.

4. The system according to claim 3, wherein the government supervision management platform is further configured to:
determine a spatiotemporal trajectory distribution based on the vehicle operational trajectory of each of the at least one vehicle within a second preset time period; and
determine the reference trajectory based on the spatiotemporal trajectory distribution and a current time period.

5. The system according to claim 4, wherein the second preset time period is related to a road control intensity of the target road.

6. The system according to claim 3, wherein the government supervision management platform is further configured to:
determine the first anomaly confidence level of each of the at least one vehicle through a vehicle identification multimodal model based on the anomalous trajectory, the vehicle thermal data, and the acoustic data of the anomaly monitoring region, wherein the vehicle identification multimodal model is a machine learning model.

7. The system according to claim 6, wherein an input of the vehicle identification multimodal model includes a vehicle type and a vehicular load of the anomaly monitoring region.

8. The system according to claim 1, wherein the smart vehicle device object platform includes a broadcast device, the control parameter further includes at least one of a broadcast parameter or a road closure parameter, the broadcast parameter includes a target non-anomalous vehicle, the road closure parameter includes a lane to be closed, and the government supervision management platform is further configured to:
determine a risk value based on the second anomaly confidence level and the anomaly type of the anomalous vehicle;
determine the control type and the control parameter based on the risk value;
in response to the control type including non-anomalous vehicle control, control, based on the broadcast parameter, the broadcast device of the target non-anomalous vehicle to operate to implement broadcasting to the target non-anomalous vehicle; and
in response to the control type including road control, control, based on the road closure parameter, a barrier gate arm of the lane to be closed to descend to achieve lane closure.

9. The system according to claim 8, wherein the road closure parameter further includes a closure duration, the closure duration is related to a road control intensity, the road control intensity is determined based on at least one of a pedestrian flow or a vehicle flow of a road on which the anomalous vehicle is traveling, and the government supervision management platform is further configured to:
when the control type includes the road control, in response to a duration for which a current lane has been closed being equal to the closure duration, control the barrier gate arm of a closed lane to ascend to achieve lane reopening.

10. A method for traffic vehicle emergency management based on an Internet of Things (IoT) large model, the method being executed by a government supervision management platform of a system for traffic vehicle emergency management based on the IoT large model, and the method comprising:
determining a first anomaly confidence level of each of at least one vehicle based on a vehicle operational trajectory, vehicle thermal data, and acoustic data of each of the at least one vehicle in at least one monitoring region of a target road;
in response to the first anomaly confidence level being greater than a confidence threshold, determining an anomalous vehicle, a second anomaly confidence level of the anomalous vehicle, and an anomaly type of the anomalous vehicle through an anomalous vehicle monitoring model based on vehicle sequence data of each of the at least one vehicle within a first preset time period, wherein the anomalous vehicle monitoring model is a machine learning model;
determining a control type and a control parameter based on the anomalous vehicle, the second anomaly confidence level of the anomalous vehicle, and the anomaly type of the anomalous vehicle, wherein the control parameter includes a warning parameter of an early warning device; and
in response to the control type being anomalous vehicle control, issuing an early warning on a travel route of the anomalous vehicle via the early warning device.

11. The method according to claim 10, wherein an input of the anomalous vehicle monitoring model includes a current time and an estimated driver fatigue value, and the estimated driver fatigue value is determined based on a vehicle type, a driver age, and a vehicle travel time.

12. The method according to claim 10, wherein the determining a first anomaly confidence level of each of at least one vehicle based on a vehicle operational trajectory, vehicle thermal data, and acoustic data of each of the at least one vehicle in at least one monitoring region of a target road includes:
determining an anomaly monitoring region containing an anomalous trajectory based on the vehicle operational trajectory of each of the at least one vehicle and a reference trajectory; and
determining the first anomaly confidence level of each of the at least one vehicle based on the anomalous trajectory, the vehicle thermal data, and the acoustic data of the anomaly monitoring region.

13. The method according to claim 12, wherein the reference trajectory is determined through operations including:
determining a spatiotemporal trajectory distribution based on the vehicle operational trajectory of each of the at least one vehicle within a second preset time period; and
determining the reference trajectory based on the spatiotemporal trajectory distribution and a current time period.

14. The method according to claim 13, wherein the second preset time period is related to a road control intensity of the target road.

15. The method according to claim 12, wherein the determining the first anomaly confidence level of each of the at least one vehicle based on the anomalous trajectory, the vehicle thermal data, and the acoustic data of the anomaly monitoring region includes:
determining the first anomaly confidence level of each of the at least one vehicle through a vehicle identification multimodal model based on the anomalous trajectory, the vehicle thermal data, and the acoustic data of the anomaly monitoring region, wherein the vehicle identification multimodal model is a machine learning model.

16. The method according to claim 15, wherein an input of the vehicle identification multimodal model includes a vehicle type and a vehicular load of the anomaly monitoring region.

17. The method according to claim 10, wherein the system for traffic vehicle emergency management based on the IoT large model further comprises a smart vehicle device object platform, the smart vehicle device object platform includes a broadcast device, the control parameter further includes at least one of a broadcast parameter or a road closure parameter, the broadcast parameter includes a target non-anomalous vehicle, the road closure parameter includes a lane to be closed, and the determining the control type and the control parameter based on the anomalous vehicle, the second anomaly confidence level, and the anomaly type of the anomalous vehicle includes:
determining a risk value based on the second anomaly confidence level and the anomaly type of the anomalous vehicle;
determining the control type and the control parameter based on the risk value;
in response to the control type including non-anomalous vehicle control, controlling, based on the broadcast parameter, the broadcast device of the target non-anomalous vehicle to operate to implement broadcasting to the target non-anomalous vehicle; and
in response to the control type including road control, controlling, based on the road closure parameter, a barrier gate arm of the lane to be closed to descend to achieve lane closure.

18. The method according to claim 17, wherein the road closure parameter further includes a closure duration, the closure duration is related to a road control intensity, the road control intensity is determined based on at least one of a pedestrian flow or a vehicle flow of a road on which the anomalous vehicle is traveling, and the method further comprises:
when the control type includes the road control, in response to a duration for which a current lane has been closed being equal to the closure duration, controlling the barrier gate arm of a closed lane to ascend to achieve lane reopening.

19. A non-transitory computer-readable storage medium, wherein the storage medium stores computer instructions, and when a computer reads the computer instructions from the storage medium, the computer executes a method for traffic vehicle emergency management based on an Internet of Things (IoT) large model, the method comprising:
determining a first anomaly confidence level of each of at least one vehicle based on a vehicle operational trajectory, vehicle thermal data, and acoustic data of each of the at least one vehicle in at least one monitoring region of a target road;
in response to the first anomaly confidence level being greater than a confidence threshold, determining an anomalous vehicle, a second anomaly confidence level of the anomalous vehicle, and an anomaly type of the anomalous vehicle through an anomalous vehicle monitoring model based on vehicle sequence data of each of the at least one vehicle within a first preset time period, wherein the anomalous vehicle monitoring model is a machine learning model;
determining a control type and a control parameter based on the anomalous vehicle, the second anomaly confidence level of the anomalous vehicle, and the anomaly type of the anomalous vehicle, wherein the control parameter includes a warning parameter of an early warning device; and
in response to the control type being anomalous vehicle control, issuing an early warning on a travel route of the anomalous vehicle via the early warning device.
